(19) United States
(12) Patent Application Publication
(10) Pub. No.: US 2004/0239102 A1
(43) Pub. Date: Dec. 2, 2004

(54) Label with multiple data and method for making same

(76) Inventors: Bruno Rollain, Le Taillan Medoc (FR); Eric Rollain, Arsac (FR); Pascal Rollain, Arsac (FR)

Correspondence Address: YOUNG & THOMPSON, 745 SOUTH 23RD STREET, 2ND FLOOR, ARLINGTON, VA, 22202, US

(21) Appl. No.: 10/486,275

(22) PCT Filed: Aug. 2, 2002
(86) PCT No.: PCT/FR02/02792

(30) Foreign Application Priority Data
Aug. 7, 2001 (FR) 01/10550

(51) Int. Cl. B42D 15/00

(52) U.S. Cl. 283/81

(57) ABSTRACT

The object of the invention is a multi-data label adapted to be fixed adhesively on the external wall of a receptacle, container or the like (B), containing or enclosing any product, constituted by the superposition of at least two sheets (1, 2) each bearing data on at least one of its surfaces, the rear sheet (2) being adapted to be fixed over all its surface against said receptacle wall, characterized in that the front sheet (1) has a first edge arranged such that the front and rear sheets (1 and 2) will be, when the label is in place, pressed against each other and in that the front sheet (1) has at least one tear-off strip (7).

The present invention relates to a multi-data label and, more generally, to a data support of the label type, secured to a receptacle, a container, any packaging containing or enclosing any product, foodstuff or not, and constituted by a plurality of sheets each bearing data.

It is already known to provide receptacles such as bottles or the like with attached elements in addition to the label or the conventional label, and constituted by supplemental labels or counter labels or by a data support of more or less complicated structure, such as a small leaflet or a structure cut out of cardboard, secured by various means to the receptacle.

Generally, these connected elements carry data connected more or less directly to the product contained in the receptacle. These systems are not practical and are costly because of their nature and their mode of emplacement.

The present invention seeks to provide a simple single multi-data means combining the various functions performed separately by known devices and which all tend to divide the usable space on the receptacle between a zone adapted for conventional and required labeling and another zone given over to a supplemental data display.

To this end, the invention has for its object a multi-data label adapted to be fixed adhesively on the external wall of the receptacle, container or the like, containing or enclosing any kind of product, constituted by a superposition of at lesser two sheets each bearing data on at lesser one of its surfaces, the rear sheet being adapted to be fixed over all its surface against said receptacle wall, characterized in that the front sheet has a first edge arranged such that the front and rear sheets will be, when the label is in place, pressed against each other, and in that the front sheet has along a second edge opposite said first edge, a tear-off strip.

According to a preferred embodiment, said first edge of the front sheet is prolonged by a portion extending beyond the rear sheet, this portion being adapted to be fixed adhesively on said receptacle wall and being separated from the rest of the sheet by a bend line that can also permit ultimate separation.

The label can have a contour of any shape or dimension, as a function particularly of the nature of the receptacle, for example a bottle of glass or plastic material containing a liquid product which is a foodstuff or not, or else a metallic box enclosing food preserves or any liquid.

According to a preferred embodiment, the label has a generally rectangular shape, the portion extending beyond the extending portion of the front sheet extending for example along one of the lateral edges of the label. Along the opposite edge is preferably provided in the front sheet a vertical detachable strip separated from the rest of the sheet by a first line of lesser resistance, said detachable strip adjoining the rear sheet and separated from this latter by a second line of lesser resistance.

To facilitate the detachment of said strip, the latter is preferably provided with a transverse line of lesser resistance delimiting a detachment notch.

The label can of course comprise more than two superposed sheets, for example three sheets, the third being interposed between said front sheet and said rear sheet and secured to this latter in line with a bend line. Thus, there is obtained a label formed of a single piece bent into three superposed flaps.

The label can also comprise four or five sheets, or even six superposed sheets.

Generally speaking, the so-called rear sheet is flanked along one of its edges of the so-called front sheet and, along an opposite edge, with successive sheets Nos. 3, 4, 5 or 6, which are accordingly separated by bend lines and are bent or rolled in accordion fashion such that the stack of sheets forms a thin flat assembly with dimensions of the so-called front sheet which has preferably the function of a conventional label, for example of a bottle of wine.

As a modification, the front sheet can be prolonged by extending beyond the rear sheet and adjacent another sheet folded between the front and rear sheets, the portion of this other sheet extending beyond the rear sheet being coated with an adhesive, and can if desired be prolonged by one or several other sheets folded or rolled in accordion fashion.

The other data available on the label are located on the internal surface of the front sheet, on the external surface of the rear sheet and on the two surfaces of the interposed supplemental sheets.

Tearing off the detachable strip frees the front sheet which can then open like the page of a book, by pivoting along said bend line of its portion that extends beyond the rear sheet. The possible intermediate sheets are thus freely accessible and can deploy or unfold.

The invention also has for its object a process for the production of such labels, more particularly, although not exclusively, adapted for the labeling of bottles of wine or the like.

More precisely, the object of the invention is a process for the production of a multi-data label of a single piece and constituted by a front sheet articulated on a rear sheet along one side of the label, the rear sheet being or not secured to one or several intermediate sheets, from a paper support having an adhesive surface and a printed surface, characterized in that the printing of the exposed surface, after emplacement of the front sheet is carried out on the adhesive surface of said sheet, whilst on the opposite surface to the adhesive surface of the rear sheet are provided printing with the help of ink preferably opacifying and a coating of lacquer over the printing.

Such a label is more particularly adapted for continuous or mechanical application.

According to another embodiment, the front sheet has an edge facing an edge of the rear sheet, the two facing edges being connected by a line of adhesive.

Other characteristics and advantages will become apparent from the description which follows, of embodiments of labels according to the invention, which description is given by way of example only and in connection with the accompanying drawings, in which:

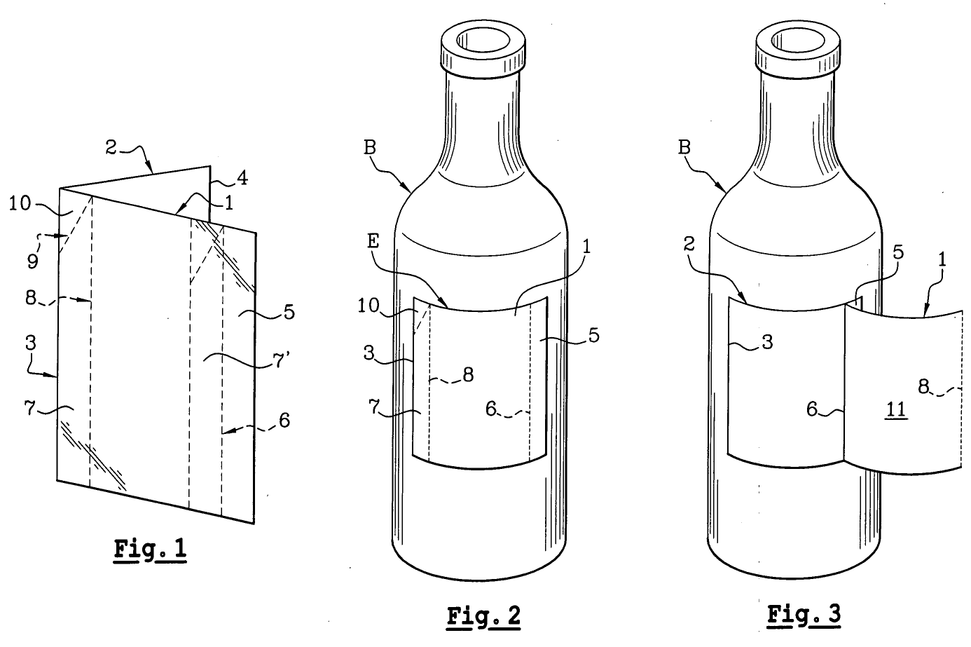

FIG. 1 is a perspective view of a label according to the invention with two sheets;

FIG. 2 shows a label of the type of FIG. 1 in place on a bottle;

FIG. 3 shows the bottle of FIG. 2 with the front sheet deployed;

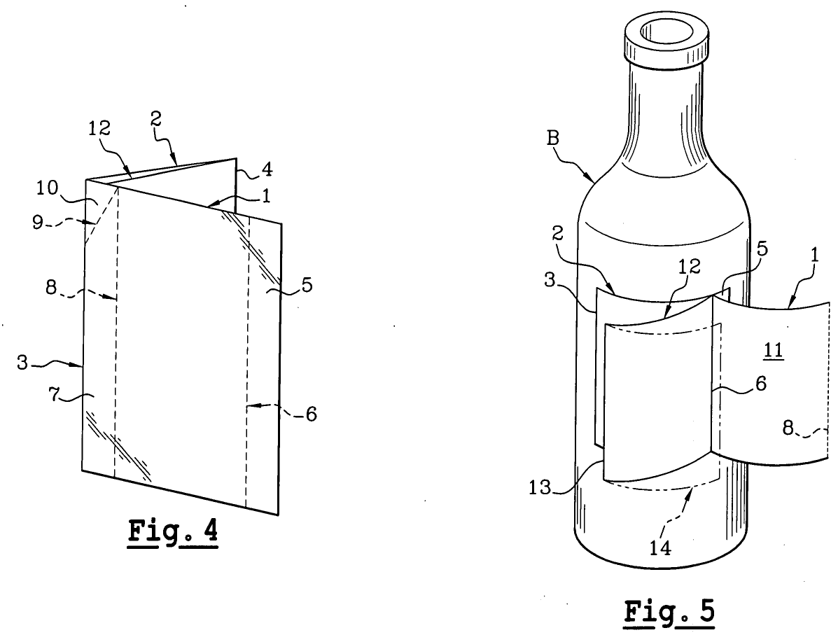

FIG. 4 is a view analogous to that of FIG. 1, showing a label with three sheets;

FIG. 5 is a view analogous to that of FIG. 3, showing the label of FIG. 4 in the deployed position of the front sheet;

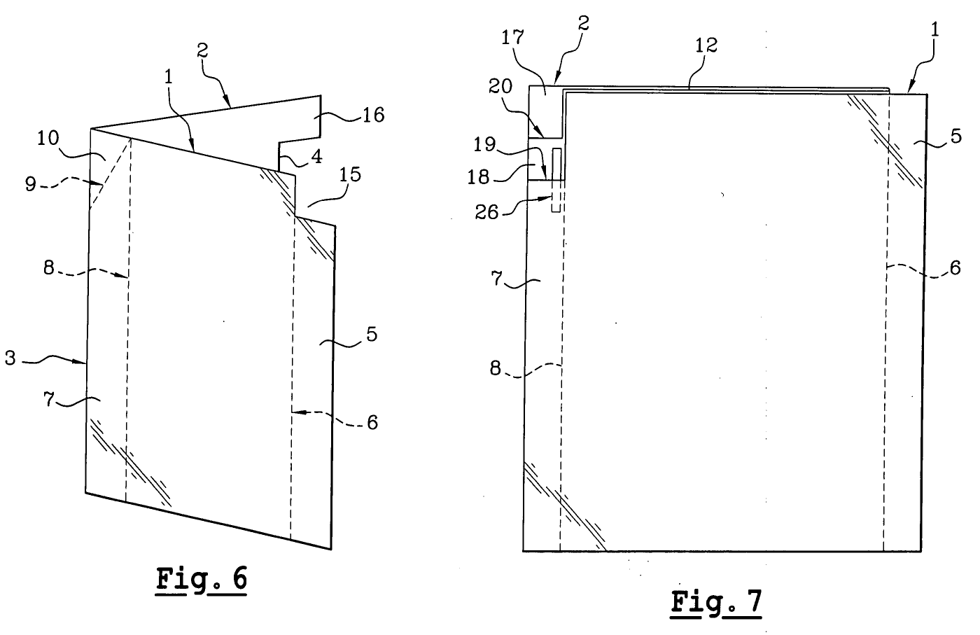

FIG. 6 shows a modified embodiment of the label with two sheets of FIG. 1,

FIG. 7 shows a modified embodiment of the label of FIG. 4;

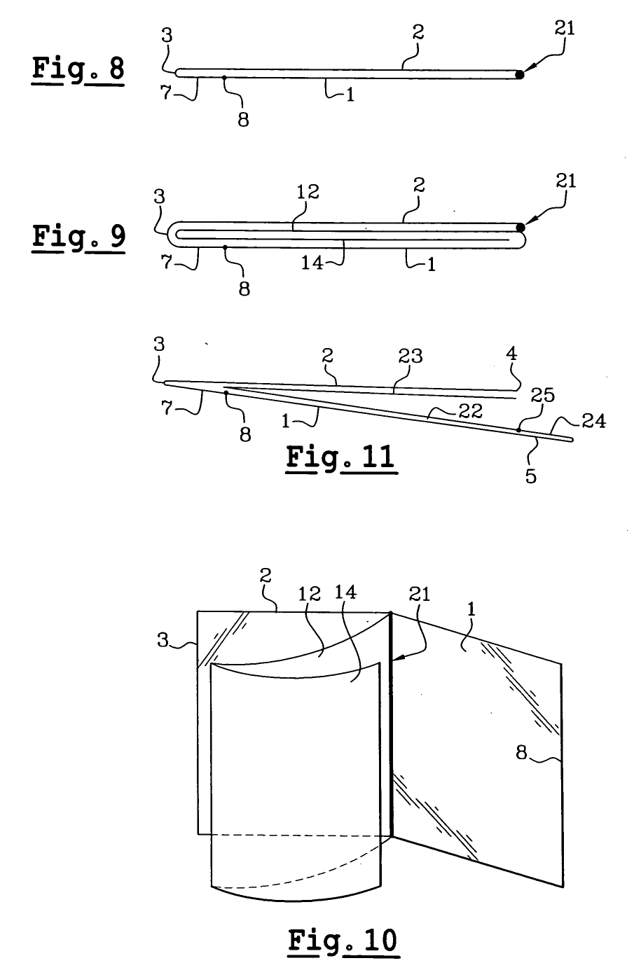

FIG. 8 is a schematic view in transverse cross-section of another embodiment of the label of FIG. 1;

FIG. 9 shows a modification of FIG. 8,

FIG. 10 is a view of a label according to claim 9 after removal of the detachable strip and deployment of the front sheet; and

FIG. 11 shows still another modification.

In FIG. 1, there is shown a label according to the invention, of rectangular format, of the type of labels for bottles of wine for example.

The label comprises two rectangular sheets adapted to be superposed, respectively a so-called front sheet 1 because it is adapted to carry conventional data of a label and hence necessarily and in all cases will be visible when the label is emplaced on the bottle, and a so-called rear sheet 2 adapted to be secured by adhesive to the bottle.

The two sheets 1, 2 are secured to the right of a bend line 3 defining for example the left vertical edge of the label, this line also having the lesser resistance to permit ultimate separation as will be seen later.

According to the invention, the front sheet 1 extends beyond the rear sheet 2, to the right for example of the right vertical edge 4 of this sheet 2.

The extending portion 5 of the sheet 1 has for example the shape of a narrow rectangular strip separated from the rest of sheet 1 by a bend line 6.

In the embodiment shown in FIG. 1, front sheet 1 also comprises on its left side a narrow rectangular strip 7, for example identical to strip 5, and separated from the rest of sheet 1 by a line 8 of lesser resistance.

Finally, in the upper portion of the strip 7 is provided a transverse line 9 of lesser resistance, delimiting a detachable triangular tab 10.

The label (1, 2) is of a single piece of material, suitably paper, cardboard, plastic film, metal, and flexible, adapted for gluing or any other securement on a flat or bowed support of any nature, according to the envisaged use.

FIG. 2 shows a label E of the type of FIG. 1 in place on a wine bottle B for example.

The front sheet 1 occupies all the visible surface of the label and carries all the usual data that are necessary or useful.

The label E is glued to the bottle, on the one hand, by the rear sheet 1, of which all the surface turned toward the bottle is secured by conventional gluing and in the usual manner and, on the other hand, by an extending strip 5 of the front sheet 1, the rear surface of said strip 5 being also entirely glued to the bottle B.

The labels E are handled and emplaced by conventional means, the labels being individualized and stored in the folded condition, the coating of glue or adhesive taking place in the known manner on the rear surface of the label whose two sheets 1, 2 are pressed against each other.

When it is desired to have access to the information carried by the internal surface of the sheet 1 and the front surface of the sheet 2, it suffices to remove the tab 10 (FIG. 2) which permits easily detaching the tear-off strip 7, the lines 3 and 8 being lines of lesser resistance. Then, the sheet 1 is deployed (FIG. 3) by pivoting to the right of line 6 in the manner of the page of a book.

It is to be noted that the position of the portions 5 and 7 of the label E can be reserved, the detachable strip 7 being to the right of the label and the sheet 1 opening toward the left of the bottle and no longer toward the right as in FIG. 3.

As a modification, the tear-off strip could be, as shown at 7′ in FIG. 1, adjacent to the line 6. In this case, after removal of the strip 7′, the sheet deploys by pivoting about the line 3. The tear-off strip could also again be vertical but at a distance from the lines 3 and 6, for example in the central region of the label, the sheet being divided after removal of the strip into two half sheets by pivoting about the lines 3 and 6 respectively.

According to still another modification, in the case of superposed flat labels, there can be provided in the front sheet 1 several parallel tear-off strips side by side, disposed horizontally.

FIG. 4 shows a modified label with three sheets, namely a front sheet 1 adjacent a rear sheet 2, itself prolonged by a third sheet 12, of the same format as the sheet 2 and interposed between the sheets 1 and 2.

The sheet 12 is free and is simply articulated on the rear sheet 2 along the edge 4 of this latter.

When the label of FIG. 4 is in place for example on a bottle, it has exactly the same appearance as the label of FIG. 2.

The deployment of the sheet 1 (FIG. 5) frees the sheet 12 which can pivot about the bend line 4 (coinciding with the line 6) to expose the data on the two surfaces of the sheet 12 as well as on the visible surface of the sheet 2 and of course the rear surface of the sheet 1.

The line 4 can be a line of lesser resistance permitting the total and clean detachment of the sheet 12 if desired. To this end, the line 4, like the bend line 3 and the lines 6 and 8, can preferably be provided with aligned micro-perforations.

If desired, the sheet 12 can be prolonged along its free edge 13 then serving as a bend line, or even a line of lesser resistance, by a fourth sheet shown in broken line at 14 in FIG. 5 and of the same format as sheet 12.

An even greater number of sheets, five, six or more, can be provided by being attached to the edge 4 of the rear sheet 2 and being folded in accordion fashion as shown in FIG. 5 or rolled.

Generally speaking, the label according to the invention is of a single piece and constituted by sheets following one after the other.

The shape of the label can be anything, rectangular, square, polygonal, curvilinear, etc. Along one side or a portion of the contour, the so-called front sheet (1) and the so-called rear sheet (2) are secured and articulated, or even detachable, although on at lesser one side or on at lesser one other portion of said contour, the so-called front sheet (1) partially extends beyond the rear sheet (2), the intermediate sheets, if there are any, such as the sheets 12 and 14 of FIGS. 4 and 5, having a format preferably but not necessarily similar to that of the rear sheet 2.

In the embodiment of FIG. 4, the sheets 1 and 2 are articulated along the left vertical edge, however the front sheet 1 extends beyond the rear sheet 2 along the right vertical edge of the label. The arrangement can of course be reversed as for the embodiment of FIG. 2.

Similarly, the articulation between the sheets 1 and 2 could be along the upper or lower horizontal edge and the extending strip 5 in the upper or lower portion of the label, provided that a detachable strip is provided, opposite the extending strip of the front sheet 1 for deployment of this latter.

The modifications of the position of the tear-off strip 7 of the embodiment of FIG. 1 are of course applicable to the embodiment of FIG. 4.

FIG. 6 shows another modified embodiment of the label of FIG. 1, according to which the strip 5 of the front sheet 1 is notched at 15 to provide a prolongation 16 of the same size as the rear sheet 2.

Once the label is in place, the strip 5 is completed by the portion 16, but the two portions of this strip can be individualized by a color code or by specific data indicating that behind the sheet 1 there are other data to be discovered.

FIG. 7 shows a same principle applied to a label of the type of FIG. 4 with three sheets, respectively 1, 2 and 12, the two invisible sheets 2 and 12 being indicated by portions respectively 17 and 18 secured to said sheets and appearing in notches provided for this purpose, namely 19 in detachable strip 7 of sheet 1 and 20 in sheet 12.

The principle of FIG. 7 is applicable to the label of FIG. 1, the notch provided in the tail of strip 7 exposing a portion of the rear sheet 2.

It is to be noted that in the label of FIG. 7, the tear-off strip 7 could be in any other place, for example adjacent the line 6.

Of course, the number, shape, dimensions and local implantations in the label of said notches or coacting prolongations could vary widely.

According to another modification, the label can comprise a front sheet 1 which does not extend beyond the rear sheet 2. To this end, the front sheet 1 comprises an edge facing an edge of the rear sheet 2, the two edges being connected, during production of the label, by an adhesive line.

FIG. 8 shows such an embodiment. There is shown at 1 the front sheet with its detachable strip 7 delimited by the line of lesser resistance 8 and the bend line 3 for separation between the front sheet 1 and the rear sheet 2, the two other opposite edges of these two sheets 1, 2 being secured together and connected by an adhesive line 21 extending over all the height of the label.

FIG. 9 shows a modification in which the rear sheet 2 is prolonged, along the adhesive line 21 connecting the sheets 1 and 2, by a first internal sheet 12, itself prolonged by a second internal sheet 14, the sheets 1, 12 and 14 being accordion folded.

It is to be noted that these same sheets could be disposed rolled up.

At 7 is designated the detachable strip of the front sheet 1, this strip being adapted, here again, to be disposed at another place, for example adjacent the line 21.

FIG. 10 shows a label according to FIG. 9, the sheet 1 being deployed, after detachment of the strip 7 which could, here again, be disposed at another place, for example adjacent the line 21.

FIG. 11 shows still another modification according to which the front sheet 1 is prolonged, opposite its edge 3 for articulation to the rear sheet 2, by a portion 5 that extends beyond the rear sheet 2, said portion 5 being itself prolonged by another sheet 22 folded between the front sheet 1 and the rear sheet 2 and itself prolonged b still another sheet 23 (or several sheets), said supplemental sheets (22, 23) being accordion folded or rolled up.

The portion 24 of the sheet 22 which extends beyond the rear sheet 2 is coated with an adhesive, this portion 24 being delimited by a line 25 facing the line 4 and ensuring the gluing of the front sheet 1 onto the support of the label.

At 7 is shown the tear-off strip of the front sheet 1. This strip 7 could be disposed at another place, for example in juxtaposition to the portion 5.

Preferably, the sheet 22 does not extend facing the tear-off strip 7. There are thus obtained labels which have on their two lateral opposite edges a same thickness (two sheets). This facilitates the flat storage of stacked labels which remain horizontal, which would not be the case if one of the edges of the labels had a different thickness from that of the other edge.

For the same reasons, the storage of such labels pre-coated with adhesive and deposited on a silicon coated strip in a roll, gives a symmetric roll.

In all the embodiments described above, the tab 10 can be replaced or completed by an associated connected element having the same function with the help for aiding in gripping the tear-off strip. This element could for example be a small strip, a pull tab, a small strip, positioned within the label and projecting at the height of the tear-off strip and ensuring easy opening. There is shown at 26 in FIG. 7 such an element constituted by a small strip inserted between the sheets 1 and 12, glued to the sheet 1 and extending outwardly with a free end accessible at the height of the portion 18. In the case of the embodiment of FIGS. 8 and 9, this element could be a filament incorporated in the adhesive line 21, the tear-off strip being adjacent this line 21.

Finally, the various sheets of the label according to the invention can carry all sorts of data connected or not to each other as well as to the product contained in the bottle, the receptacle, the container, etc. provided with said label and being individualized by any graphics, colors, etc.

It is to be noted that a flat electronic chip can be disposed within the label, on one of the surfaces of a sheet, for the purpose for example of traceability or control.

The invention also has for its object a process for production of such labels, in particularly labels such as those shown in the drawings and adapted for continuous or mechanical application.

To this end, the invention has for its object a process for production of a multi-data label of a single piece and constituted by a front sheet articulated on a rear sheet 2 along a side 3 of the label, the rear sheet 2 being or not secured to one or several intermediate sheets 12, 14 from a paper support having a gluing surface and a printing surface, characterized in that the printing of the exposed surface, after application of the front sheet 1, is carried out on the gluing surface of said sheet 1, whilst on the surface opposite to the gluing surface of the rear sheet 2 is provided printing with the help of an ink that is preferably opacifying and a coating of a lacquer over the printing.

In such a label, the exposed surface after application is, like the rear surface 2 glued on the bottle B, on the gluing surface of the paper support. It is thus known that this gluing surface has a physical appearance (matte and rough) different from that (smoother) of the surface adapted for printing.

This permits particularly producing self-sticking labels stored in a roll.

Moreover, the use of an opacifying ink for the production of printing on the exposed surface of the rear sheet 2 and of a coating of a lacquer over the printing on this same surface, on the one hand avoids gluing the sheet pressed against the rear sheet and, on the other hand, permits carrying out printing which will not appear on the exposed surface of the applied label.

In the absence of such lacquer, the glue of the gluing surface of the rear sheet 2 might migrate through this latter.

It is to be noted that it is possible to reproduce on the exposed surface of the rear sheet 2 the data content of the exposed surface (front sheet 1) of the label, thereby satisfying the regulation for wine labels, requiring that the support of this data content must necessarily adhere over all the surface of the container.

1. Multi-data label adapted to be secured adhesively on the external wall of a receptacle, container or the like (B), containing or enclosing any product, constituted by a superposition of at lesser two sheets (1, 2) secured together each bearing data on at lesser one of its surfaces, the rear sheet (2) being adapted to be secured over all its surface against said receptacle wall, the front sheet (1) having a first edge arranged such that the front and rear sheets (1 and 2) will be, when the label is in place, pressed against each other characterized in that the front sheet (1) has at lesser one tear-off strip.

2. Label according to claim 1, characterized in that said first edge of the front sheet (1) is prolonged by a portion (5) that extends beyond the rear sheet (2), this portion being adapted to be fixed adhesively on said receptacle wall and being separated from the rest of the sheet (1) by a bend line (6) that can also permit possible separation.

3. Label according to claim, 1 characterized in that said first edge of the front sheet (1) is prolonged by a portion (5) that extends beyond the rear sheet (2) adjacent another sheet folded between said front and rear sheets (1 and 2), the portion of this other sheet extending beyond the rear sheet (2) being adapted to be fixed adhesively on said receptacle wall, said other sheet being if desired prolonged by one or several other sheets bent in accordion fashion or rolled.

4. Label according to claim 1, characterized in that said first edge of the front sheet (1) faces an edge of the rear sheet (2), the two facing edges being connected by an adhesive line (21).

5. Label according to claim 1, characterized in that said tear-off strip (7) adjoins said first edge of the front sheet (1).

6. Label according to claim 1, characterized in that said tear-off strip (7) adjoins another edge of the front sheet (1).

7. Label according to claim 1, characterized in that said tear-off strip (7) is parallel to two opposite edges of the front sheet (1) and spaced from each of these edges.

8. Label according to claim 1, characterized in that it comprises several parallel tear-off strips, side by side, disposed parallel or orthogonal to said first edge of the front sheet (1).

9. Label according to claim 2, characterized in that it is of a single piece and constituted by adjacent sheets (1, 2, 12, 14), the front sheet (1) being articulated to the rear sheet (2) along one side or one portion of the contour of the label, said tear-off strip (7) adjoining the bent edge (3) of the front and rear sheets (1 and 2).

10. Label according to claim 9, characterized in that the sheets (1, 2, 12, 14) have a rectangular shape and are accordion folded or rolled.

11. Label according to claim 10, characterized in that the front sheet (1) has an extending strip (5) along one lateral edge of the label, the tear-off strip (7) being provided along the opposite lateral edge, adjoining the rear sheet (2) and separated from this latter by a first line of lesser resistance (3) as well as from the rest of the front sheet (1) by a second line of lesser resistance (8).

12. Label according to claim 1, characterized in that the or each tear-off strip (7) comprises means facilitating detachment, such as a tab (10) and/or a connected element (26) that projects.

13. Label according to claim 1, characterized in that the bend lines (3, 4, 13) separating the various sheets (1, 2, 12, 14) and/or the lines of separation (6, 8) provided on the front sheet (1) comprise micro-perforations.

14. Label according to claim 2, characterized in that the extending strip (5) of the front sheet (1) is provided with a notch (15) exposing a portion (16) of the rear sheet (2).

15. Label according to claim 1, characterized in that the tear-off strip (7) is provided with a notch (19) exposing a portion (17, 18) of at least one of the sheets (1, 2, 12).

16. Process for the production of a label according to claim 1, from a paper support having a gluing surface and a printing surface, characterized in that the printing of the exposed surface, after application, of the front sheet (1) is provided on the gluing surface of said sheet (1), whilst on the surface opposite the gluing surface of the rear sheet (2) is provided printing with the help of a preferably opacifying ink and a coating of a varnish over the printing.

17. Label according to claim 3, characterized in that it is of a single piece and constituted by adjacent sheets (1, 2, 12, 14), the front sheet (1) being articulated to the rear sheet (2) along one side or one portion of the contour of the label, said tear-off strip (7) adjoining the bent edge (3) of the front and rear sheets (1 and 2).

18. Label according to 9, characterized in that the extending strip (5) of the front sheet (1) is provided with a notch (15) exposing a portion (16) of the rear sheet (2).

19. Label according to 17, characterized in that the extending strip (5) of the front sheet (1) is provided with a notch (15) exposing a portion (16) of the rear sheet (2).
